(19) United States
(12) Patent Application Publication
(10) Pub. No.: US 2008/0157690 A1
(43) Pub. Date: Jul. 3, 2008

(54) Electromagnetic energy distributions for electromagnetically induced mechanical cutting

(75) Inventors: Ioana M. Rizoiu, San Clemente, CA (US); Dmitri Boutoussov, Dana Point, CA (US); Jeffrey W. Jones, Robertson, WY (US); Andrew I. Kimmel, San Clemente, CA (US)

Correspondence Address: STOUT, UXA, BUYAN & MULLINS LLP, 4 VENTURE, SUITE 300, IRVINE, CA, 92618, US

(73) Assignee: BIOLASE Technology, Inc.

(21) Appl. No.: 11/821,409

(22) Filed: Jun. 22, 2007

Related U.S. Application Data
(63) Continuation-in-part of application No. 11/523,492, filed on Sep. 18, 2006.
Application No. 11/523,492 is a continuation-in-part of application No. 11/475,719, filed on Jun. 26, 2006.
Application No. 11/475,719 is a continuation-in-part of application No. 09/848,010, filed on May 2, 2001, now abandoned.

(51) Int. Cl. H05B 41/30

(52) U.S. Cl. 315/200 A; 315/246; 250/526

(57) ABSTRACT

Output optical energy pulses including relatively high energy magnitudes at the beginning of each pulse are disclosed. As a result of the relatively high energy magnitudes which lead each pulse, the leading edge of each pulse includes a relatively large slope. This slope is preferably greater than or equal to 5. Additionally, the full-width half-max value of the output optical energy distributions are between 0.025 and 250 microseconds and, more preferably, are about 70 microseconds. A flashlamp is used to drive the laser system, and a current is used to drive the flashlamp. A flashlamp current generating circuit includes a solid core inductor which has an inductance of 50 microhenries and a capacitor which has a capacitance of 50 microfarads.

This application is a continuation-in-part of co-pending U.S. application Ser. No. 11/523,492, filed Sep. 18, 2006 and entitled ELECTROMAGNETIC ENERGY DISTRIBUTIONS FOR ELECTROMAGNETICALLY INDUCED MECHANICAL CUTTING (Att. Docket BI9066CON4), which is commonly assigned and the contents of which are expressly incorporated herein by reference. This application is also a continuation-in-part of co-pending U.S. application Ser. No. 11/475,719, filed Jun. 26, 2006 and entitled VISUAL FEEDBACK IMPLEMENTS FOR ELECTROMAGNETIC ENERGY OUTPUT DEVICES (Att. Docket BI9936P), and U.S. application Ser. No. 09/848,010, filed May 2, 2001 and entitled DERMATOLOGICAL CUTTING AND ABLATING DEVICE (Att. Docket BI485P), both of which are commonly assigned and the contents of which are expressly incorporated herein by reference.

### BACKGROUND OF THE INVENTION

1. Field of the Invention

The present invention relates generally to lasers and, more particularly, to output optical energy distributions of lasers.

2. Description of Related Art

A variety of laser systems are present in the prior art. A solid-state laser system generally comprises a laser rod for emitting coherent light and a stimulation source for stimulating the laser rod to emit the coherent light. Flashlamps are typically used as stimulation sources for Erbium laser systems, for example. The flashlamp is driven by a flashlamp current, which comprises a predetermined pulse shape and a predetermined frequency.

The flashlamp current drives the flashlamp at the predetermined frequency, to thereby produce an output flashlamp light distribution having substantially the same frequency as the flashlamp current. This output flashlamp light distribution from the flashlamp drives the laser rod to produce coherent light at substantially the same predetermined frequency as the flashlamp current. The coherent light generated by the laser rod has an output optical energy distribution over time that generally corresponds to the pulse shape of the flashlamp current.

The pulse shape of the output optical energy distribution over time typically comprises a relatively gradually rising energy that ramps up to a maximum energy, and a subsequent decreasing energy over time. The pulse shape of a typical output optical energy distribution can provide a relatively efficient operation of the laser system, which corresponds to a relatively high ratio of average output optical energy to average power inputted into the laser system.

The prior art pulse shape and frequency may be suitable for thermal cutting procedures, for example, where the output optical energy is directed onto a target surface to induce cutting. New cutting procedures, however, do not altogether rely on laser-induced thermal cutting mechanisms. More particularly, a new cutting mechanism directs output optical energy from a laser system into a distribution of atomized fluid particles located in a volume of space just above the target surface. The output optical energy interacts with the atomized fluid particles causing the atomized fluid particles to expand and impart electromagnetically-induced mechanical cutting forces onto the target surface. As a result of the unique interactions of the output optical energy with the atomized fluid particles, typical prior art output optical energy distribution pulse shapes and frequencies have not been especially suited for providing optical electromagnetically-induced mechanical cutting. Specialized output optical energy distributions are required for optimal cutting when the output optical energy is directed into a distribution of atomized fluid particles for effectuating electromagnetically-induced mechanical cutting of the target surface.

### SUMMARY OF THE INVENTION

The output optical energy distributions of the present invention comprise relatively high energy magnitudes at the beginning of each pulse. As a result of these relatively high energy magnitudes at the beginning of each pulse, the leading edge of each pulse comprises a relatively large slope. This slope is preferably greater than or equal to 5. Additionally, the full-width half-max (FWHM) values of the output optical energy distributions are greater than 0.025 microseconds. More preferably, the full-width half-max values are between 0.025 and 250 microseconds and, more preferably, are between 10 and 150 microseconds. The full-width half-max value is about 70 microseconds in the illustrated embodiment. A flashlamp is used to drive the laser system, and a current is used to drive the flashlamp. A flashlamp current generating circuit comprises a solid core inductor having an inductance of about 50 microhenries and a capacitor having a capacitance of about 50 microfarads.

The present invention, together with additional features and advantages thereof, may best be understood by reference to the following description taken in connection with the accompanying illustrative drawings.

### BRIEF DESCRIPTION OF THE DRAWINGS

FIG. 1 is a plot of flashlamp-driving current versus time according to the prior art;

FIG. 2 is a plot of output optical energy versus time for a laser system according to the prior art;

FIG. 3 is a schematic circuit diagram illustrating a circuit for generating a flashlamp-driving current in accordance with the present invention;

FIG. 4 is a plot of flashlamp-driving current versus time in accordance with the present invention; and

FIG. 5 is a plot of output optical energy versus time for a laser system in accordance with the present invention;

FIG. 6 is a block diagram showing a fluid output used in combination with an electromagnetic energy source having a flashlamp driving circuit in accordance with the present invention;

FIGS. 7 and 8 illustrate a particular embodiment of an electromagnetically induced cutter that can be used with the invention;

FIGS. 9-19 illustrate various configurations of the present invention for imparting electromagnetically-induced disruptive forces onto a target surface;

FIG. 20 illustrates a hand-held piece having a parabolic mirror or prism, a moisture source, and a suction source;

FIG. 21 illustrates a hand-held piece having a fiber optic, a moisture source, and a suction source;

FIG. 22 illustrates a hand-held piece having a parabolic mirror or prism, at least two moisture sources, and a suction source;

FIG. 23 illustrates a hand-held piece having a fiber optic, at least two moisture sources, and a suction source;

FIG. 24 illustrates a hand-held piece having a fiber optic, a mixing chamber, and a suction source;

FIG. 25 illustrates a hand-held piece having a parabolic mirror or prism, at least one moisture source, and a suction source; and

FIG. 26 illustrates a hand-held piece having a removable spacer and moisture source.

### DETAILED DESCRIPTION OF THE PRESENTLY PREFERRED EMBODIMENTS

Referring more particularly to the drawings, FIG. 1 illustrates a plot of flashlamp-driving current versus time according to the prior art. The flashlamp-driving current 10 initially ramps up to a maximum value 12. The initial ramp 14 typically comprises a slope (current divided by time) of between 1 and 4. After reaching the maximum value 12, the flashlamp-driving current 10 declines with time, as illustrated by the declining current portion 16. The prior art flashlamp-driving current 10 may typically comprise a frequency or repetition rate of 1 to 15 hertz (Hz). Additionally, the flashlamp-driving current 10 of the prior art may typically comprise a pulse width greater than 300 microseconds. The full-width half-max value of the flashlamp-driving current 10 is typically between 250 and 300 microseconds. The full-width half-max value is defined as a value of time corresponding to a length of the full-width half-max range plotted on the time axis. The full-width half-max range is defined on the time axis from a beginning time, where the amplitude first reaches one half of the peak amplitude of the entire pulse, to an ending time, where the amplitude reaches one half of the peak amplitude a final time within the pulse. The full-width half-max value is the difference between the beginning time and the ending time.

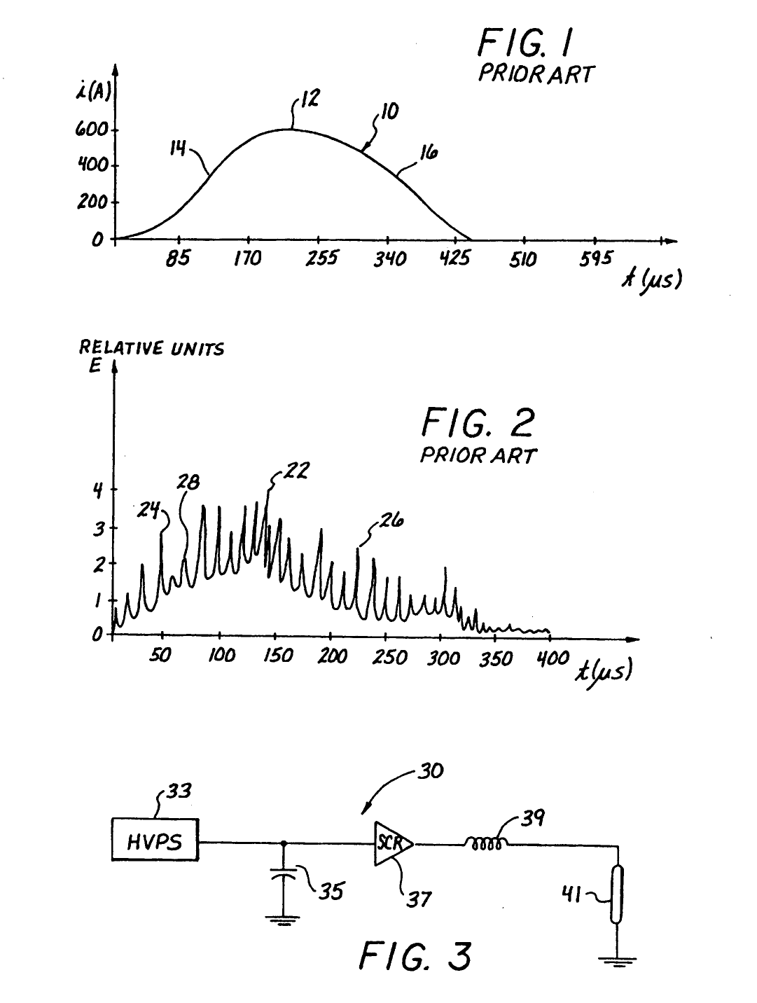

FIG. 2 illustrates a plot of energy versus time for the output optical energy of a typical prior art laser. The output optical energy distribution 20 generally comprises a maximum value 22, an initial ramp 24, and a declining output energy portion 26. The micropulses 28 correspond to population inversions within the laser rod as coherent light is generated by stimulated emission. The average power of the laser can be defined as the power delivered over a predetermined period of time, which typically comprises a number of pulses. The efficiency of the laser system can be defined as a ratio of the output optical power of the laser, to the input power into the system that is required to drive the flashlamp. Typical prior art laser systems are designed with flashlamp-driving currents 10 and output optical energy distributions 20 which optimize the efficiency of the system.

FIG. 3 illustrates a flashlamp-driving circuit 30 according to the presently preferred embodiment. The flashlamp-driving circuit 30 comprises a high-voltage power supply 33, a capacitor 35, a rectifier 37, an inductor 39, and a flashlamp 41. The capacitor 35 is connected between the high-voltage power supply 33 and ground, and the flashlamp 41 is connected between the inductor 39 and ground. The high-voltage power supply 33 preferably comprises a 1500 volt source, having a charging rate of 1500 Joules per second. The flashlamp 41 may comprise a 450 to 700 torr source and, preferably, comprises a 450 torr source. The capacitor 35 preferably comprises a 50 microfarad capacitor, and the rectifier 37 preferably comprises a silicon-controlled rectifier. The inductor 39 preferably comprises a 50 microhenry solid-core inductor. In alternative embodiments, the inductor 39 may comprise a 13 microhenry inductance. In still other alternative embodiments, the inductor 39 may comprise inductance values of between 10 and 15 micro-henries. Other values for the inductor 39 and the capacitance 35 may be implemented in order to obtain flashlamp-driving currents having relatively large leading amplitudes, for example, as discussed below.

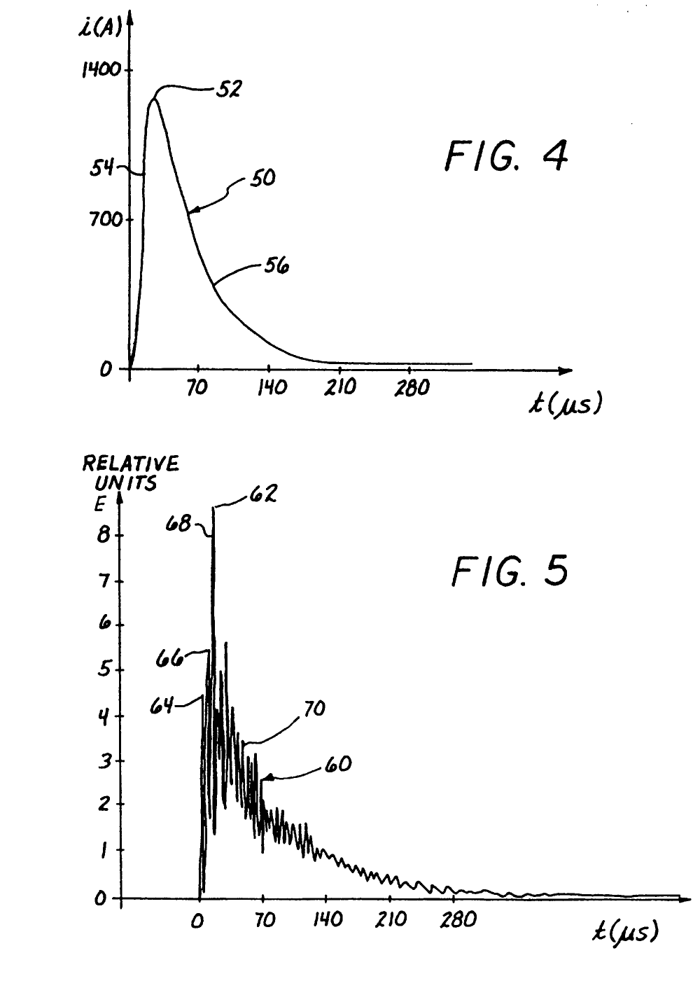

FIG. 4 illustrates the flashlamp driving current 50 of the present invention, which passes from the inductor 39 to the flashlamp 41. The flashlamp driving current of the present invention preferably has a pulse width which is greater than about 0.25 microseconds and, more preferably, which is in a range of 100 to 300 mircoseconds. In the illustrated embodiment, the pulse width is about 200 microseconds. The flashlamp driving current 50 comprises a maximum value 52, an initial ramp portion 54, and a declining current portion 56. The flashlamp 41 preferably comprises a cylindrical glass tube having an anode, a cathode, and a gas therebetween such as Xenon or Krypton. An ionizer circuit (not shown) ionizes the gas within the flashlamp 41. As the flashlamp-driving current 50 is applied to the anode of the flashlamp 41, the potential between the anode and the cathode increases. This potential increases as the flashlamp-driving current increases, as indicated by the initial ramp 54. Current flows through the gas of the flashlamp 41, resulting in the flashlamp 41 emitting bright incoherent light.

The flashlamp 41 is close-coupled to laser rod (not shown), which preferably comprises a cylindrical crystal. The flashlamp 41 and the laser rod are positioned parallel to one another with preferably less than 1 centimeter distance therebetween. The laser rod is suspended on two plates, and is not electrically connected to the flashlamp-driving current circuit 30. Although the flashlamp 41 comprises the preferred means of stimulating the laser rod, other means are also contemplated by the present invention. Diodes, for example, may be used instead of flashlamps for the excitation source. The use of diodes for generating light amplification by stimulated emission is discussed in the book Solid-State Laser Engineering, Fourth Extensively Revised and Updated Edition, by Walter Koechner, published in 1996, the contents of which are expressly incorporated herein by reference.

The incoherent light from the presently preferred flashlamp 41 impinges on the outer surface of the laser rod. As the incoherent light penetrates into the laser rod, impurities within the laser rod absorb the penetrating light and subsequently emit coherent light. The impurities may comprise erbium and chromium, and the laser rod itself may comprise a crystal such as YSGG, for example. The presently preferred laser system comprises either an Er, Cr:YSGG solid state laser, which generates electromagnetic energy having a wavelength in a range of 2.70 to 2.80 microns, or an erbium, yttrium, aluminum garnet (Er:YAG) solid state laser, which generates electromagnetic energy having a wavelength of 2.94 microns. As presently preferred, the Er, Cr:YSGG solid state laser has a wavelength of approximately 2.78 microns and the Er:YAG solid state laser has a wavelength of approximately 2.94 microns. According to one alternative embodiment, the laser rod may comprises a YAG crystal, and the impurities may comprise erbium impurities. A variety of other possibilities exist, a few of which are set forth in the above-mentioned book Solid-State Laser Engineering, Fourth Extensively Revised and Updated Edition, by Walter Koechner, published in 1996, the contents of which are expressly incorporated herein by reference. Other possible laser systems include an erbium, yttrium, scandium, gallium garnet (Er:YSGG) solid state laser, which generates electromagnetic energy having a wavelength in a range of 2.70 to 2.80 microns; an erbium, yttrium, aluminum garnet (Er:YAG) solid state laser, which generates electromagnetic energy having a wavelength of 2.94 microns; chromium, thulium, erbium, yttrium, aluminum garnet (CTE:YAG) solid state laser, which generates electromagnetic energy having a wavelength of 2.69 microns; erbium, yttrium orthoaluminate (Er:YAL03) solid state laser, which generates electromagnetic energy having a wavelength in a range of 2.71 to 2.86 microns; holmium, yttrium, aluminum garnet (Ho:YAG) solid state laser, which generates electromagnetic energy having a wavelength of 2.10 microns; quadrupled neodymium, yttrium, aluminum garnet (quadrupled Nd:YAG) solid state laser, which generates electromagnetic energy having a wavelength of 266 nanometers; argon fluoride (ArF) excimer laser, which generates electromagnetic energy having a wavelength of 193 nanometers; xenon chloride (XeCl) excimer laser, which generates electromagnetic energy having a wavelength of 308 nanometers; krypton fluoride (KrF) excimer laser, which generates electromagnetic energy having a wavelength of 248 nanometers; and carbon dioxide (C02), which generates electromagnetic energy having a wavelength in a range of 9 to 11 microns.

Particles, such as electrons, associated with the impurities absorb energy from the impinging incoherent radiation and rise to higher valence states. The particles that rise to metastable levels remain at this level for periods of time until, for example, energy particles of the radiation excite stimulated transitions. The stimulation of a particle in the metastable level by an energy particle results in both of the particles decaying to a ground state and an emission of twin coherent photons (particles of energy). The twin coherent photons can resonate through the laser rod between mirrors at opposing ends of the laser rod, and can stimulate other particles on the metastable level, to thereby generate subsequent twin coherent photon emissions. This process is referred to as light amplification by stimulated emission. With this process, a twin pair of coherent photons will contact two particles on the metastable level, to thereby yield four coherent photons. Subsequently, the four coherent photons will collide with other particles on the metastable level to thereby yield eight coherent photons.

The amplification effect will continue until a majority of particles, which were raised to the metastable level by the stimulating incoherent light from the flashlamp 41, have decayed back to the ground state. The decay of a majority of particles from the metastable state to the ground state results in the generation of a large number of photons, corresponding to an upwardly rising micropulse (64, for example, FIG. 5). As the particles on the ground level are again stimulated back up to the metastable state, the number of photons being emitted decreases, corresponding to a downward slope in the micropulse 64, for example. The micropulse continues to decline, corresponding to a decrease in the emission of coherent photons by the laser system. The number of particles stimulated to the metastable level increases to an amount where the stimulated emissions occur at a level sufficient to increase the number of coherent photons generated. As the generation of coherent photons increases, and particles on the metastable level decay, the number of coherent photons increases, corresponding to an upwardly rising micropulse.

The output optical energy distribution over time of the laser system is illustrated in FIG. 5 at 60. The output optical energy distribution of the present invention preferably has a pulse width that is greater than about 0.25 microseconds and, more preferably, in a range of 125 to 300 mircoseconds. In the illustrated embodiment, the pulse width is about 200 microseconds. The output optical energy distribution 60 comprises a maximum value 62, a number of leading micropulses 64, 66, 68, and a portion of generally declining optical energy 70.

According to the present invention, the output optical energy distribution 60 comprises a large magnitude. This large magnitude corresponds to one or more sharply-rising micropulses at the leading edge of the pulse. As illustrated in FIG. 5, the micropulse 68 comprises a maximum value 62 which is at or near the very beginning of the pulse. Additionally, the full-width half-max value of the output optical energy distribution in FIG. 5 is approximately 70 microseconds, compared to full-width half-max values of the prior art typically ranging from 250 to 300 microseconds. Applicant's invention contemplates pulses comprising full-width half-max values greater than 0.025 microseconds and, preferably, ranging from 10 to 150 microseconds, but other ranges may also be possible. Additionally, Applicant's invention contemplates a pulse width of between 0.25 and 300 microseconds, for example, compared to typical prior-art pulse widths which are greater than 300 microseconds. Further, a frequency of 20 Hz is presently preferred. Alternatively, a frequency of 30 Hz may be used. Applicants' invention generally contemplates frequencies between 1 and 100 Hz, compared to prior art frequencies typically ranging from 1 to 15 Hz.

As mentioned above, the full-width half-max range is defined from a beginning time, where the amplitude first rises above one-half the peak amplitude, to an ending time, where the amplitude falls below one-half the peak amplitude a final time during the pulse width. The full-width half-max value is defined as the difference between the beginning time and the ending time.

The location of the full-width half-max range along the time axis, relative to the pulse width, is closer to the beginning of the pulse than the end of the pulse. The location of the full-width half-max range is preferably within the first half of the pulse and, more preferably, is within about the first third of the pulse along the time axis. Other locations of the full-width half-max range are also possible in accordance with the present invention. The beginning time preferably occurs within the first 10 to 15 microseconds and, more preferably, occurs within the first 12.5 microseconds from the leading edge of the pulse. The beginning time, however, may occur either earlier or later within the pulse. The beginning time is preferably achieved within the first tenth of the pulse width.

Another distinguishing feature of the output optical energy distribution 70 is that the micropulses 64, 66, 68, for example, comprise approximately one-third of the maximum amplitude 62. More preferably, the leading micropulses 64, 66, 68 comprise an amplitude of approximately one-half of the maximum amplitude 62. In contrast, the leading micropulses of the prior art, as shown in FIG. 2, are relatively small in amplitude.

The slope of the output optical energy distribution 60 is greater than or equal to 5 and, more preferably, is greater than about 10. In the illustrated embodiment, the slope is about 50. In contrast, the slope of the output optical energy distribution 20 of the prior art is about 4.

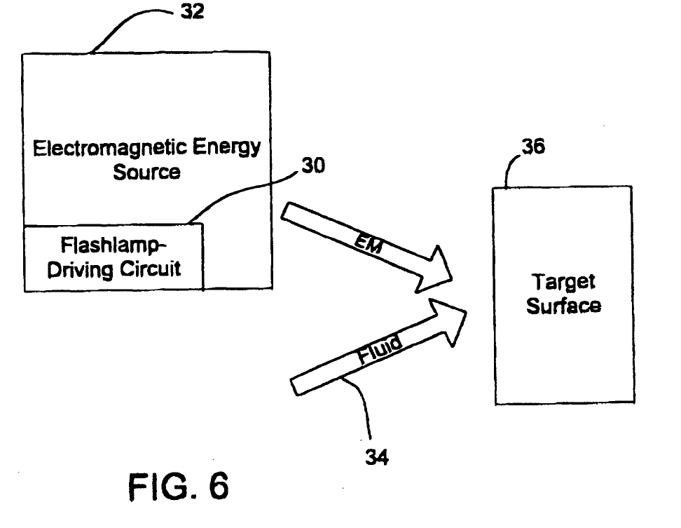

The output optical energy distribution 60 of the present invention is useful for maximizing a cutting effect of an electromagnetic energy source 32, such as a laser driven by the flashlamp driving circuit 30, directed into an atomized distribution of fluid particles 34 above a target surface 3, as shown in FIG. 6. An apparatus for directing electromagnetic energy into an atomized distribution of fluid particles above a target surface is disclosed in U.S. Pat. No. 5,741,247, entitled ATOMIZED FLUID PARTICLES FOR ELECTROMAGNETICALLY INDUCED CUTTING, the entire contents of which are incorporated herein by reference. The high-intensity leading micropulses 64, 66, and 68 impart large amounts of energy into atomized fluid particles which preferably comprise water, to thereby expand the fluid particles and apply mechanical cutting forces to the target surface of, for example, tooth enamel, tooth dentin, tooth cementum, bone, and cartilage, skin, mucosa, gingiva, muscle, heart, liver, kidney, brain, eye or vessels. The trailing micropulses after the maximum micropulse 68 have been found to further enhance the cutting efficiency. According to the present invention, a single large leading micropulse 68 may be generated or, alternatively, two or more large leading micropulses 68 (or 64, 66, for example) may be generated.

The flashlamp current generating circuit 30 of the present invention generates a relatively narrow pulse, which is on the order of 0.25 to 300 microseconds, for example. Additionally, the full-width half-max value of the optical output energy distribution 60 of the present invention preferably occurs within the first 70 microseconds, for example, compared to full-width half-max values of the prior art occurring within the first 250 to 300 microseconds. The relatively quick frequency, and the relatively large initial distribution of optical energy in the leading portion of each pulse of the present invention, results in efficient mechanical cutting. If a number of pulses of the output optical energy distribution 60 were plotted, and the average power determined, this average power would be relatively low, compared to the amount of energy delivered to the laser system via the high-voltage power supply 33. In other words, the efficiency of the laser system of the present invention may be less than typical prior art systems. Since the output optical energy distributions of the present invention are uniquely adapted for imparting electromagnetic energy into atomized fluid particles over a target surface, however, the actual cutting of the present invention is optimized. The cutting effect obtained by the output optical energy distributions of the present invention is both clean and powerful and, additionally, provides a consistent cut. The terms “cut” and “cutting” are broadly defined herein as imparting disruptive mechanical forces onto the target surface.

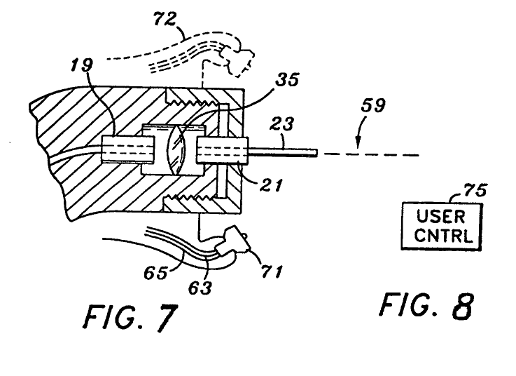

With reference to FIGS. 7 and 8, a handpiece of the invention can comprise a fiber optic guide 23, which can be placed into close proximity of the target surface. This fiber optic guide 23, however, preferably does not actually contact the target surface. Since the atomized fluid particles from the nozzle 71 are placed into the interaction zone 59, the purpose of the fiber optic guide 23 can be for placing laser energy into this interaction zone, as well. One feature of the present invention is the cleaning effect of the air and water, from the nozzle 71, on the fiber optic guide 23. The present inventors have found that this cleaning effect is optimal when the nozzle 71 is pointed somewhat directly at the target surface. For example, debris from the cutting are removed by the spray from the nozzle 71.

Additionally, the present inventors have found that this orientation of the nozzle 71, pointed toward the target surface, enhances the cutting efficiency of the present invention. Each atomized fluid particle contains a small amount of initial kinetic energy in the direction of the target surface. When electromagnetic energy from the fiber optic guide 23 contacts an atomized fluid particle, the exterior surface of the fluid particle acts as a focusing lens to focus the energy into the water particle's interior. The focused electromagnetic energy is absorbed by the water particle, causing the interior of the water particle to heat and explode rapidly. This exothermic explosion cools the remaining portions of the exploded water particle. The surrounding atomized fluid particles further enhance cooling of the portions of the exploded water particle. A pressure-wave is generated from this explosion. This pressure-wave, and the portions of the exploded water particle of increased kinetic energy, are directed toward the target surface. The incident portions from the original exploded water particle, which are now traveling at high velocities with high kinetic energies, and the pressure-wave, can impart strong, concentrated, at least partially mechanical forces onto the target surface.

These at least partially mechanical forces can cause the target surface to break apart from the material surface through a “chipping away” action. The target surface does not undergo vaporization, disintegration, or charring. The chipping away process can be repeated by the present invention until the desired amount of material has been removed from the target surface. The nozzle 71 is preferably configured to produce atomized sprays with a range of fluid particle sizes narrowly distributed about a mean value.

FIGS. 9-19 illustrate various configurations for imparting non-thermal or reduced-thermal electromagnetically-induced disruptive forces onto a target surface, such as skin. A primary purpose of the present invention is to place electromagnetic energy, from an Er, Cr:YSGG laser, for example, into an atomized distribution of fluid particles, above the target surface. The energy from the laser is absorbed by the atomized fluid particles, causing the atomized fluid particles to expand and impart disruptive forces onto the target surface. A key feature in accordance with one aspect of the present invention is the absorption of the electromagnetic radiation by the fluid particles in the interaction zone, and the subsequent cutting imparted to the target surface. The term “cutting” is intended to encompass ablating and other types of disruptive forces that can be imparted onto a target surface.

Applicants have found that the distribution of particles imparted onto or directly in front of a fiber optic tip can form an interaction zone in front of the tip. The fiber optic serves to transport the concentrated electromagnetic energy through extraneous or stray fluid particles and into what Applicants refer to as an interaction zone, where high absorption of the electromagnetic energy subsequently occurs near to the target. Applicants have observed that the presently embodied electromagnetic radiation, which is highly absorbed by the specified fluid, and the combining of this electromagnetic radiation with the fluid particles at the tip of a fiber optic, will limit the penetration of the electromagnetic radiation through the mist to a predetermined depth. After this depth any electromagnetic radiation continuing through the mist is reduced or negligible, relative to the particular application at hand, during this cutting mode. As the electromagnetic radiation passes further and further into the interaction zone, its energy is absorbed more and more by the fluid particles, until hardly any, and eventually none, of the electromagnetic radiation remains. There is a point, or zone, wherein the thermal cutting forces are reduced substantially or eliminated, and wherein the cutting forces from the absorption of the electromagnetic radiation by the fluid particles, is optimal.

The high absorption of the electromagnetic energy by the fluid particles, resulting in expansion of the fluid particles, is a key element of one aspect of the present invention. A target must be placed within or near this interaction zone in order for the disruptive forces, from the absorption of the electromagnetic radiation by the fluid particles, to be optimally imparted onto the target surface.

One feature of the present invention is to maintain a bounded layer of fluid particles, which is not too thick and which is not too thin. The bounded layer of fluid particles may be of a relatively high density in order to optimize the absorption of electromagnetic energy in the layer and to ensure that substantial thermal cutting forces from the electromagnetic energy are attenuated or preferably substantially eliminated, being transformed into the fluid particles instead, so that the expansion of the fluid particles performs the cutting of the target surface. A relatively low-density distribution of fluid particles, spanning a relatively large distance, would absorb the incident electromagnetic radiation, resulting in fluid particles expanding well above the target surface. Any remaining radiation in the fluid particle distribution near the target surface would be too weak to induce the required high absorption and resulting cutting forces.

In addition to being bounded to enable the delivery of concentrated electromagnetic energy into the layer of fluid particles, the layer should be bounded to facilitate the very-close positioning of the target surface to the incident electromagnetic radiation. More particularly, the target surface should be placed at the boundary or within the interaction zone, so that the disruptive forces resulting from the expansion of the fluid particles occur near the target and do not need to travel far before being imparted onto the target. Thus, it can be seen that a fiber optic tip placed into a distribution of fluid particles and, additionally, placed in close proximity (2-3 mm, for example) of a target surface, creates a thin layer of fluid particles between the incident, concentrated electromagnetic energy and the target surface. Other distances are possible within the scope of the present invention, depending on, for example, the selected laser intensity and wavelength, the selected fluid, and the selected distribution of atomized fluid particles. The below embodiments disclose, for example, other means for creating a bounded layer of fluid particles between the incident, concentrated electromagnetic energy and the target surface.

Turning to FIG. 9, an electromagnetically induced cutter 121 is illustrated comprising a laser 123, microprocessor 125 and user interface 127. The electromagnetically induced cutter 121 further comprises an air and/or water source 129 for supplying one or more atomization nozzles 131 with air and/or water. A scanning housing 133 is connected between the motor 135 and the air and/or water supply 129. The scanning housing 133 inputs optical energy from the laser 123, and further inputs air and/or water from the air and/or water supply 129. Both the motor 135 and the laser 123 are preferably controlled by the microprocessor 125 in accordance with one or more user inputs from the user interface 127. The motor 135 is adapted to scan both the fiber optic 137 from the laser 123 and at least one atomization nozzle 131 connected to the air and/or water supply 129, to achieve predetermined scanning patterns on the surface of the target.

In the illustrated embodiment, the scanning housing 133 is placed directly onto or supported above the target, such as the patient's skin, and the motor 135 moves both the fiber optic 137 and the attached atomization nozzles 131, to achieve predetermined scanning patterns on the target. In the illustrated embodiment, the two atomization nozzles 131 are fixed to a fiber optic coupler 139 by arms, and the air and water lines 141 connected to the atomization nozzles 131 are flexible. Additionally, in one preferred embodiment, the fiber optic 137 from the laser within the scanning housing 133 is flexible to allow deflection by the motor 135. U.S. Pat. No. 5,474,549 and U.S. Pat. No. 5,336,217 disclose fibers that are deflected to achieve scanning patterns on a target surface. The entire contents of these two patents are incorporated herein by reference to illustrate structure which can be implemented by the present invention to achieve, for example, scanning.

A very broad aspect of the present invention comprises supplying an atomized distribution of fluid particles in the path of a beam to achieve electromagnetically induced cutting. The beam can be scanned, as shown in FIGS. 9 to 19, or a housing of the beam can be moved over the target surface to thereby scan or advance the beam, as shown in FIGS. 20-26. In the illustrated embodiment of FIG. 9, the output tip of the fiber optic 137 is preferably maintained a few millimeters from the target. In the embodiment of FIG. 9, the entire lower surface of the scanning housing 133 is open. Other embodiments may comprise smaller openings which are only large enough to allow energy from the scanned fiber optic 137 to exit the scanning housing. In modified embodiments, a transparent member may be provided over the lower surface of the scanning housing 133 or the smaller opening to protect the internal components of the scanning housing 133.

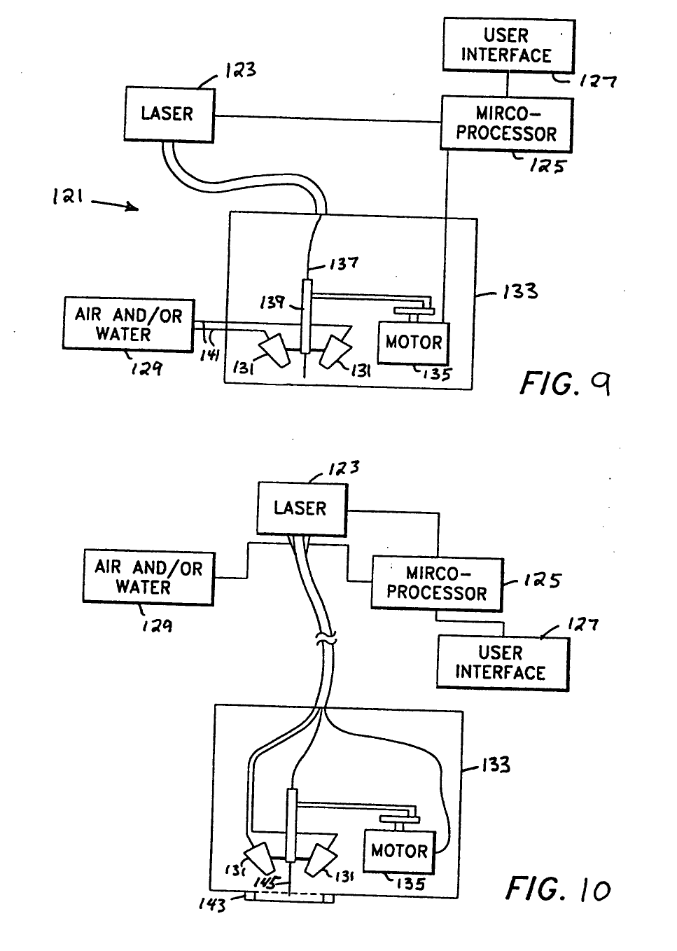

FIG. 10 illustrates an embodiment wherein the scanning housing 133 comprises the motor 135. In the embodiment of FIG. 10, a small opening exists, which as illustrated generally comprises a diameter equal to the distance between the two atomization nozzles 131. The size of this opening can be configured during design and manufacture thereof to accommodate the desired scanning patterns achievable by the motor and fiber optic combination. In FIG. 10, a ring 143 is attached at the bottom of the scanning housing 133. In the absence of the ring 143, in an event in one embodiment where the scanning housing is placed on the target surface, such as skin, although such placement is not required, the fiber optic tip 145 is close to or touches the target surface. The ring 143 of FIG. 10 can thus provide an exact spacing between the fiber optic tip 145 (for outputting radiation) and the target surface, by contacting the target or a perimeter surface of the target.

The ring can be configured to comprise a mist disk, as discussed in connection with FIGS. 11-16 below. In the embodiments of FIGS. 9 and 10, as well as the following embodiments discussed in connection with FIGS. 20-26, the microprocessor or other circuitry can be programmed or constructed to vary the velocities of the atomized fluid particles, the sizes of the atomized fluid particles, the distributions of the atomized fluid particles, as well as other parameters of the atomized fluid particles, in accordance with desired cuts to be achieved. Additionally, these parameters of the atomized fluid particles may be varied in accordance with the surface being disrupted (for example, particular type or condition of skin or other type of soft tissue) by the electromagnetically induced cutter. In the embodiments of FIGS. 9 and 10, as well as the additional embodiments illustrated in the following figures, a surface-profile imager/generator can be implemented to provide a computer generated model of a surface being scanned, as disclosed in U.S. Pat. No. 5,588,428. A visible beam, for example, may be used to collect profile information of the skin target surface. The electromagnetic energy from the fiber optic tip can be scanned accordingly in the embodiments of FIGS. 9 and 10, and especially in the embodiments of FIGS. 11 to 13 where a collimated beam is not necessarily used. Additionally, the amount and properties of the atomized fluid particles may be varied in accordance with different areas and/or disruptive forces desired to be imparted onto the modeled surface or different areas of the modeled surface.

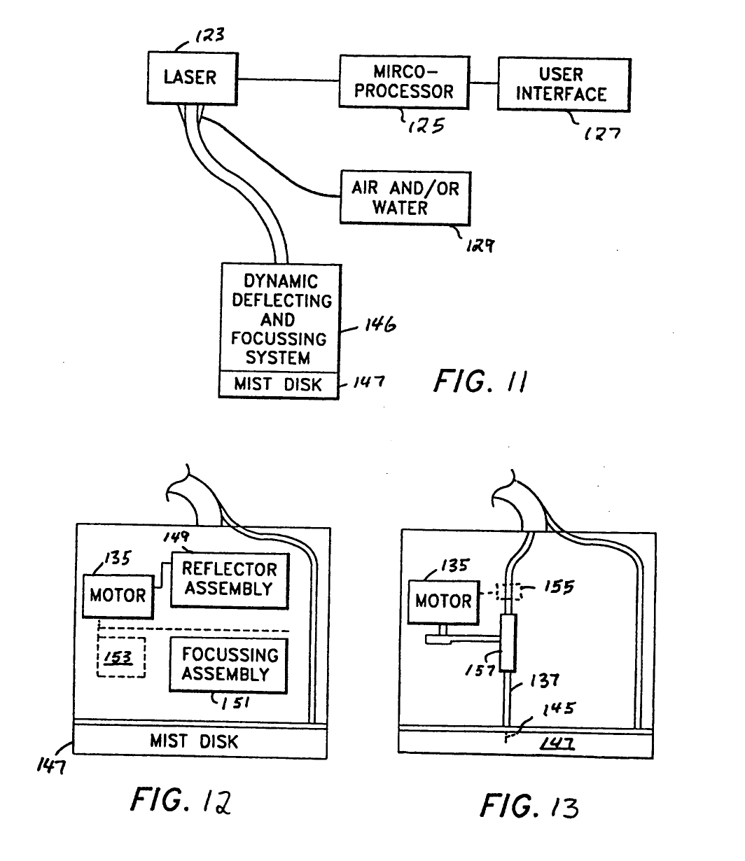

In the embodiments of FIGS. 9 and 10, the actual optical fiber is scanned using a motor assembly. Although the optical fiber may be scanned using a motor assembly in FIGS. 11 and 12, one embodiment of these figures can comprise the scanning of non-collimated electromagnetic energy using reflectors and focusing lenses, as is known in the art. U.S. Pat. No. 5,624,434, and patents and references cited therein, disclose apparatuses which scan a non-collimated beam using dynamically controlled deflectors, the contents of which are expressly incorporated herein by reference. In other embodiments, such as disclosed below in connection with FIGS. 20-26, similar technology may be incorporated in hand-held pieces, wherein a few or substantially all of the parts therein are fixed and do not move, and wherein the hand piece is moved instead. In FIG. 11, a fiber optic feeds a scanning head with the laser energy from a laser 123, and subsequently, the laser energy exits the fiber optic and is deflected with motor-controlled mirrors or other means and is passed through focusing lenses at 146. The focused beam then passes through a mist disk 147 before impinging on the target surface. The mist disk 147 is preferably configured to generate a thin layer of atomized fluid particles just over the target. The mist disk 147 may be configured to have circular or other geometrical shapes. In the illustrated exemplary embodiment, the mist disk 147 generates a layer of atomized fluid particles that is approximately 2 to 3 millimeters thick. Thinner and thicker layers are possible in substantially modified embodiments.

The atomized fluid particles themselves are generally preferred to be on the order of microns in diameter. In a preferred embodiment, the atomized fluid particles have diameters within a range of about 40 to 60 microns. In other embodiments, the atomized fluid particles have diameters of approximately 200 microns. Other diameters are also possible in accordance with the present invention, so long as electromagnetically induced cutting is optimized for the desired application or maximized and thermal effects, preferably, are attenuated or eliminated during implementation of substantially non-thermal cutting operations. Since the electromagnetic energy from the laser is preferably highly absorbed by the atomized fluid particles, for the reduced-thermal mode of cutting, the layer of atomized fluid particles just above the target should be relatively thin in the presently preferred embodiment. In alternative embodiments, the layer of atomized fluid particles may be greater than 2 to 3 millimeters, but the amount of laser energy and/or characteristics of the distribution of atomized fluid particles may need to be adjusted accordingly so that cutting is maximized and thermal effects are attenuated or eliminated during implementation of substantially non-thermal cutting operations. For example, for a substantially thicker layer of atomized fluid particles a substantially greater laser energy concentration may need to be introduced to penetrate the greater thickness of the layer of atomized fluid particles and to generate the preferred cutting effects on the surface. The dynamic deflecting and focusing system may comprise, for example, one or more motors controlling one or more deflecting lenses, and/or one or more focusing optics, for focusing the deflected electromagnetic energy above the target surface just above or within the mist disk. Each motor can comprise a galvanic motor or stepper motor, for example.

FIG. 12 illustrates a schematic example where a motor 135 controls a reflector assembly 149, and a focusing assembly 151 is disposed between the reflector assembly 149 and the mist disk 147. A shutter 153 may be used, as shown in phantom in FIG. 12, for blocking the electromagnetic energy during intermediate positions between deflections, as is known in the art. In accordance with the present invention, the mist disk 147 is placed between the target surface and the incident electromagnetic energy to provide the thin layer of atomized fluid particles. FIG. 13 illustrates a very thin mist disk 147, for providing an even thinner distribution of atomized fluid particles between the incident electromagnetic energy and the target. In FIG. 13, a motor 135 is used to scan a fiber optic 137. A coupling 155 is illustrated in phantom to the right of the motor, as an alternative to the coupling 157 illustrated below and to the right of the motor, for scanning the fiber optic 137. Positioning of the coupling connector further away from the output tip 145 of the fiber optic 137 results in small movements of the coupling connector for scanning the output tip 145 of the fiber optic 137. In the presently preferred embodiment, the fiber optic 137 is flexible in a region between where the fiber optic 137 enters the scanning housing and where the fiber optic is controlled by the motor 135. The fiber optic 137, however, is preferably rigid or stiff in a region between the coupling of the fiber optic by the motor 135 and the output tip 145 of the fiber optic 137.

FIGS. 14-16 illustrate exemplary embodiments of mist disks in accordance with the present invention. FIG. 14a is a side-elevation view of a mist disk 160, and FIG. 14b is a bottom planar view of a mist disk 160. Although mist disks are described and illustrated, any assembly for providing a thin layer of atomized fluid particles just above the target surface may be implemented, provided the laser energy can be concentrated into the layer of particles. For example, a single nozzle (without a mist disk) may be placed just adjacent to a fiber optic for providing an atomized distribution of fluid particles to the fiber optic or other means of introducing electromagnetic radiation, and the electromagnetic radiation may or may not be scanned. (See, for example, FIGS. 20-26.) Additionally, one or more nozzles may be placed in conjunction with the fiber optic just above the target surface being scanned. The one or more nozzles may be scanned, themselves, as illustrated, for example, in FIGS. 9, 10, 18 and 19, or the nozzles may be fixed to the handpiece, as illustrated, for example, in FIGS. 20-26.

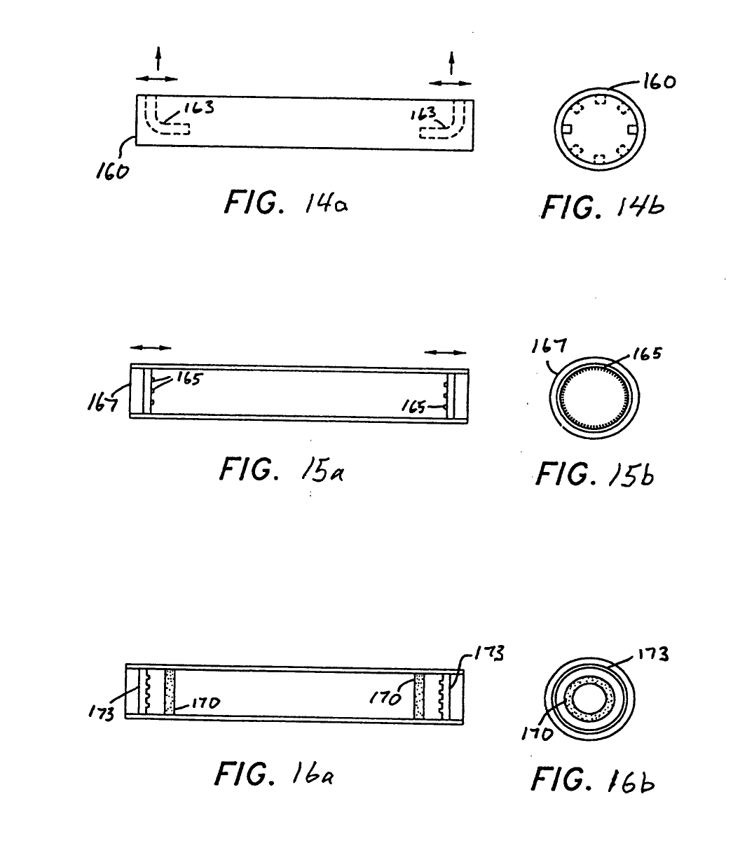

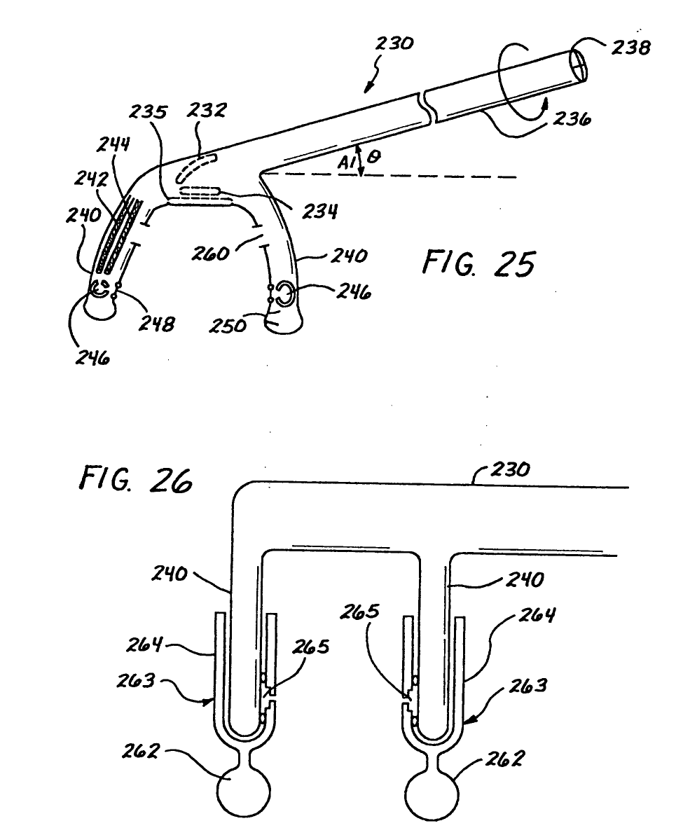

In FIGS. 14a and 14b, two nozzles 163 for outputting atomized fluid particles are placed within the disk 160 at one hundred eighty degrees from each other. The two nozzles 163 are supplied with air and/or water to generate a thin layer of atomized fluid particles. The thin layer of atomized fluid particles is preferably consistent over the scanning pattern or fixed location (e.g., FIG. 25 embodiment) of the electromagnetic energy impinging on the target surface. In addition to two nozzles, a greater number of nozzles 163 may be implemented, as shown in phantom in FIG. 14b. The number of atomization nozzles may be adjusted according to design parameters. FIGS. 15a and 15b illustrate an embodiment where several fine nozzle outputs 165 are placed along the height of the mist disk 167. In FIG. 15b, a relatively large number of output nozzles 165 are also distributed along an inner circumference of the mist disk 167. The number of nozzles 165 along the height and along the circumference of the mist disk 167 can be adjusted in accordance with design parameters. The double-ended arrows shown in FIGS. 14a and 15a show that, in alternative embodiments, the nozzles within the disks may be moved along the axes of the arrows. In the presently preferred embodiment, the mist disks are removable from the scanning housing, and are all interchangeable, to thereby accommodate a large variety of different atomized distribution patterns which can be placed above the target surface. FIGS. 16a and 16b illustrate another embodiment where a misting substance 170, such as a fabric or a very thin screen, or other substance, is placed between the radially outwardly located air and/or water supply lines/sources 173 and the scanning area of the electromagnetic energy. FIGS. 16a and 16b illustrate a plurality of output nozzles being positioned radially outwardly of the material, but in alternative embodiments only a single output nozzle may be supplied along the height in the mist disk.

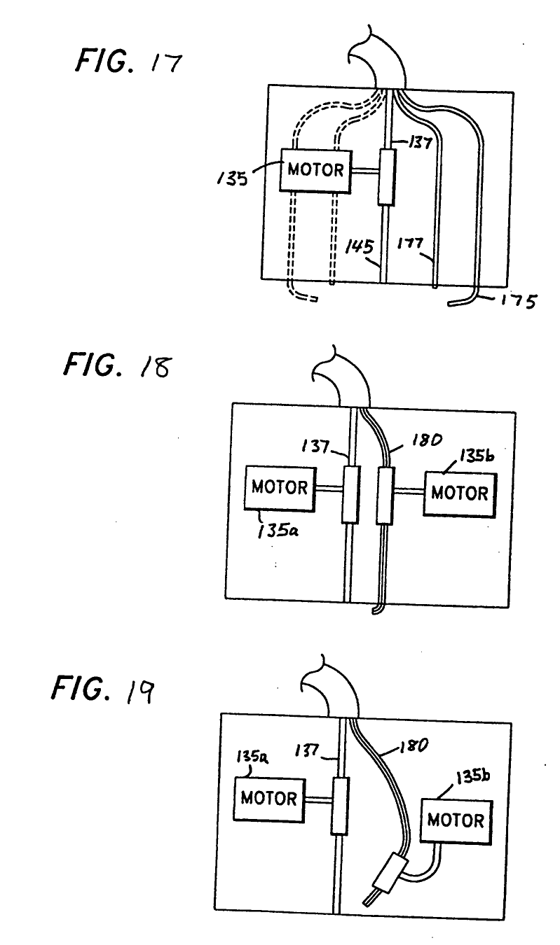

FIG. 17 illustrates a scanning housing where a motor 135 scans a fiber optic 137, and where a single air supply 175 is directed in a direction above the target surface basically parallel to the surface being scanned by the fiber optic 137. A fluid supply 177 is positioned between the scanned fiber optic 137 and the pressurized air supply 175, for directing fluid, such as water, into a pressurized exit path of the air supply 175. With a proper construction of the exit of the fluid line 177, the resulting combination of the pressurized air line 175 and fluid line 177 is to create a distribution of fluid particles between the scanned fiber tip 145 and the target surface.

The air and water lines may be placed closer to the fiber optic in alternative embodiments and may be configured in various orientations relative to one another, so long as fluid particles are generated in a distribution comprising a thin layer above the target surface. An additional air and water supply line is illustrated in phantom in FIG. 17, and additional air and water lines may be added in accordance with design parameters.

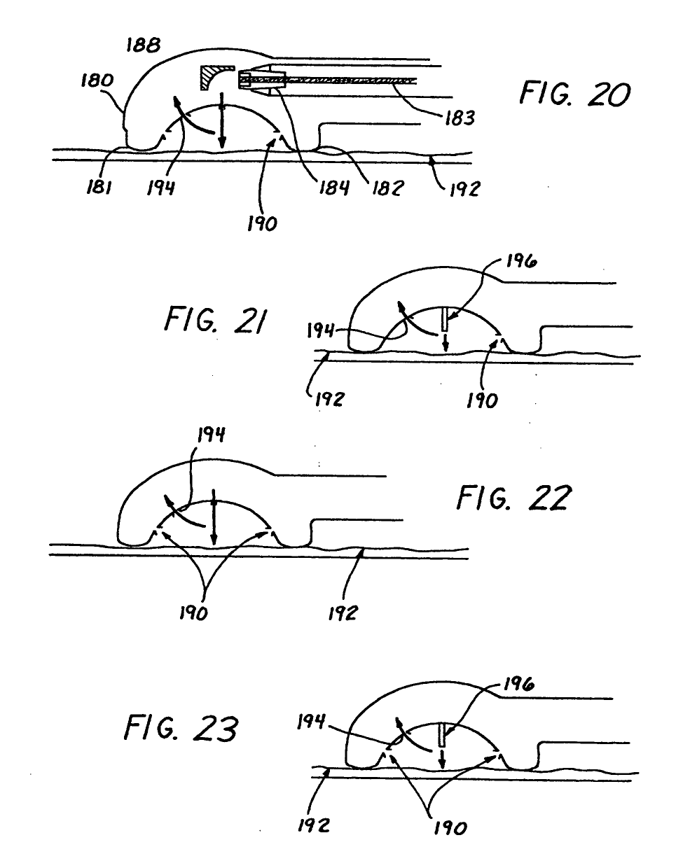

FIG. 18 illustrates an embodiment where a motor 135a scans a fiber optic 137 and where, additionally, a motor 135b scans an air and/or water line 180. The two motors are preferably designed to work together to optimize a placement of atomized fluid particles at the output of the scanned fiber optic 137, to thereby achieve consistent results on the target surface. FIG. 19 illustrates an additional embodiment where a second motor 135b is used to scan an air and/or water supply 180 to dynamically place a consistent layer of atomized fluid particles in front of the output end of the movable fiber optic 137. The two motors may work together, based upon information obtained by a surface model of the target being scanned, for example, the surface model being predetermined or computer generated in accordance with known technology, such as disclosed in U.S. Pat. No. 5,588,428.

Delivery systems comprising hand-held pieces with few or no moving parts are disclosed in FIGS. 20-26. In the embodiments of FIGS. 20-26 the handpieces themselves are moved to advance the electromagnetic energy over the target surface, as distinguished from the electromagnetic energy being scanned within the housings. It was mentioned above that in other embodiments similar technology may be incorporated into hand-held pieces wherein few or substantially all of the parts therein are fixed and do not move, and wherein the hand-held pieces are moved instead. It was also mentioned, in connection with the mist disks of FIGS. 14-16, that any assembly for providing a thin layer of atomized fluid particles just above the target surface may be implemented such as, for example, a single nozzle (without a mist disk) placed just adjacent to a fiber optic for providing an atomized distribution of fluid particles to the fiber optic or other means of introducing electromagnetic radiation, and the electromagnetic radiation may or may not be scanned. The above disclosure is thus intended to apply to the embodiments of FIGS. 20-26, as well.

In FIG. 20, a handpiece 180 comprises a trunk fiber optic 183 coupled to a ferrule 184 for outputting electromagnetic radiation onto a reflector 188, which preferably comprises a mirror, parabolic mirror or prism. The handpiece 180 comprises a first tissue contacting arm 181 and a second tissue contacting arm 182. The two tissue contacting arms 181, 182 are preferably disposed opposite to one another. In accordance with a modified embodiment, one or more contacting arms (as distinguished from two tissue contacting arms) may be used, taking on basically any form so long as the one or more contacting arms provide a function of spacing the source of electromagnetic energy from the target surface. For example, in one modified embodiment, the one or more contacting arms may comprise a mist disk. In another modified embodiment, the one or more contacting arms may be constructed to contact another surface, such as another part of the patient, the patient's chair, or the floor, while still providing the function of spacing the source of electromagnetic energy from the target surface. In other modified embodiments, three or more tissue contacting arms may be disposed at, for example, about 120 degrees, 240 degrees and 360 degrees. In another embodiment, the tissue contacting arm or arms are part of and form at least a partial enclosure, such as a hemispherical enclosure. In yet another embodiment, the tissue contacting arms form at least a partial cylindrical, rectangular or other enclosure. The contacting surface of the enclosure (i.e., the surface that contacts the target surface) may thus comprise one or more points for actually touching the target surface (corresponding to one or more contacting legs), or may comprise a circular, oval, rectangular or other continuous or non-continuous perimeter for actually touching the target surface. For example, the contacting arms may form an oval, hemispherical enclosure, such as that of an upside down spoon, wherein the contacting surface of the oval, hemispherical enclosure forms an oval shape or edge for touching the target surface. Thus, in use, an oval shape on the target surface would be enclosed by the oval, hemispherical configuration.

As used herein, the term “hemispherical” is not intended to define half of a sphere but, rather, to define any closed surface with an opening for contacting the target surface. Thus, in an embodiment wherein the hemispherical configuration forms a rectangular edge for contacting the target surface, the enclosure may have any of a variety of shapes such as for example half or a sphere that transitions into the rectangular edge, or an open ended cubical enclosure with the rectangular edge. The general shapes constructions of the one or more contacting arms, as set forth in this paragraph, also apply to the embodiments described below with reference to FIGS. 21-26. The distal ends of the tissue contacting arms are preferably rounded or smooth-surfaced to allow the tissue contacting arms to glide over the target surface, such as a patient's skin, tissue, crystal or glass. In one modified embodiment, at least one of the distal ends comprises a ball roller.

A moisture output 190 directs moist air and/or water or an atomized air/water spray into the path of the electromagnetic energy from the parabolic mirror or prism 188. Water from the moisture output 190 can help to allow the tissue contacting arms to slide over the target surface. In one embodiment, water or another fluid, or an additive to water, having lubricating properties, may be emitted from the moisture output 190. For example, soft water may be emitted from the moisture output 190. As presently preferred, the moisture output 190 comprises an atomizer for outputting atomized fluid particles into the path of the electromagnetic energy above or on the target surface 192, and the parabolic mirror or prism 188 focuses the electromagnetic energy into an interaction zone above, on or within (interstitially) the target surface 192. A suction 194 removes excess moist air and/or atomized fluid particles. The suction 194 is preferably disposed opposite to the moisture output 190 to facilitate a fluid flow path from the moisture output 190, through the interaction zone, and out through the suction 194.

FIG. 21 illustrates a similar configuration, with a fiber optic tip 196 carrying the electromagnetic energy to the interaction zone. As presently embodied, the fiber optic tip 196 terminates adjacent to the interaction zone, but other configurations are also possible. FIGS. 22 and 23 correspond to the embodiments of FIGS. 20 and 21, respectively, with each of FIGS. 22 and 23 comprising an additional moisture output 190.

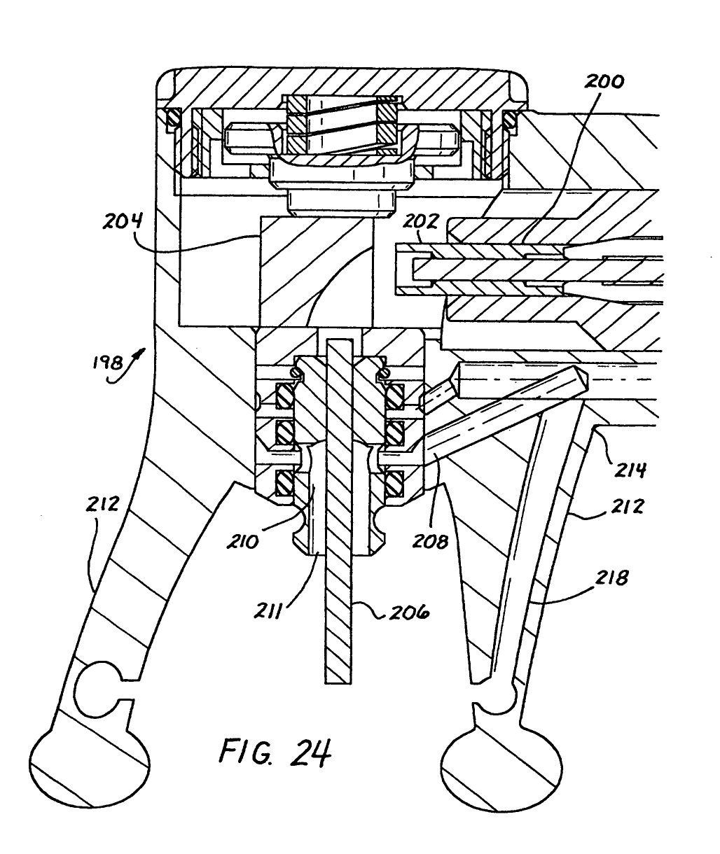

FIG. 24 illustrates a hand-held piece with a fiber optic 200 terminating within a ferrule 202. Electromagnetic energy from the fiber optic 200 impinges on a parabolic reflector or prism 204 and is then focused into the fiber tip 206. Air and water lines 208 direct air and water into a mixing chamber 210 for mixing and subsequent emission from the output 211 along the fiber tip 206 toward the target surface. As with the embodiment of FIG. 20, the target surfaces of FIGS. 21-26 preferably comprise skin, but may alternatively comprise other materials such as crystal or glass. In accordance with a presently preferred embodiment, water particles from the mixing chamber 210 intersect the propagation path of electromagnetic energy from the fiber tip 206 within an interaction zone above the target surface. At least one tissue contacting arm 212 extends from the handpiece 198 for contacting the target surface. As with the embodiments of FIGS. 20-24, the tissue contacting arms and the structure of the hand-held piece 230 bridging the tissue contacting arms together, may be formed of stainless steel or a plastic, for example. Part or all of the tissue contacting arms and bridging structure may be formed of a transparent material, such as a transparent plastic.

At least one of the tissue contacting arms 212 comprises a proximal end 214, a distal end 216, and a suction passageway 218 extending therebetween. Each suction passageway 218 is preferably constructed to carry surplus fluids and debris from the target surface. In order to facilitate this end, one or more of the rounded surfaces (e.g., ball rollers) at the distal ends 216 may be configured to have a smaller or flatter profile to place the relative position(s) of the suction passageway 218 opening(s) closer to the target surface. In one embodiment, the opening or openings of the suction passageway(s) 218 may be placed within the rounded surface(s) or ball roller(s) at the distal end(s) 216. Each suction passageway 218 removes water particles that have been emitted from the mixing chamber 210 and carries them proximally through the suction passageway 218 and out of the handpiece 198. Another suction passageway may be disposed in a second tissue contacting arm 220.

Additional tissue contacting arms may be implemented, such as a third tissue contacting arm, with or without additional suction passageways. In another embodiment, the tissue contacting arms are part of and form an enclosure, such as a hemispherical enclosure. The distal ends of the tissue contacting arms are preferably rounded or smooth-surfaced to allow the tissue contacting arms to slide over the target surface, such as a patient's skin. In a modified embodiment, one or more of the distal ends may comprise a ball roller. Regardless of the shape of the distal end of the tissue contacting arm, water from the moisture output 210 (or, for example, the moisture output 190 of FIGS. 20-23) or can help the tissue contacting arm or arms glide over the target surface. The air and water lines 208 may be configured to output, soft water or another fluid, or an additive to water, having lubricating properties. As with the embodiments of FIGS. 20-24, the tissue contacting arms and the structure of the hand-held piece 230 bridging the tissue contacting arms together, may be formed of stainless steel or a plastic, for example. Part or all of the contacting arms 240 and the bridging structure may be formed of a transparent material, such as a transparent plastic.

As an alternative to the mixing chamber 210 of FIG. 24, one or more atomizers, mist generators, mist disks, or moist air outputs may be used instead and/or disposed in or connected to one or more of the tissue contacting arms 212. The atomizers, mist generators, mist disks, or moist air outputs are preferably constructed to place atomized fluid particles or moist air into an interaction zone within the path of the electromagnetic energy from the fiber tip 206 above the target surface. In a modified embodiment, the fiber tip 206 is omitted and the parabolic mirror or prism 204 or another suitable light bender, is used to focus or direct electromagnetic energy directly into an interaction zone or onto the target surface. In one embodiment, the electromagnetic energy is focused into an interaction zone above the target surface. In other embodiments in connection with FIGS. 20-26, with or without a fiber tip 206, and with a mixing chamber or alternatively with an atomizer, mist generator, mist disk, or moist air output, the electromagnetic energy can be directed onto the target surface with one or more collimating, focusing, or diverging optics or reflectors.

For example, with reference to FIG. 25, a hand-held piece 230 comprises a mirror, parabolic mirror or prism 232 (shown in phantom) and an output optic 234 (shown in phantom) which comprises a collimating, focusing, or diverging lens. A trunk fiber optic (not shown) directs electromagnetic radiation onto the parabolic mirror or prism 232, and the parabolic mirror or prism 232 bends the electromagnetic radiation into the output optic 234 for subsequent output of the electromagnetic radiation through the output lens 235. As presently embodied, the mirror 232 and output optic 234 are disposed and protected within the hand-held piece 230, and the output lens 235 is exposed for cleaning. In a modified embodiment, the output optic 234 and the output lens 235 may comprise an integral unit

In FIG. 25 a shaft portion 236 of the hand-held piece 238 is preferably constructed to rotatably connect to a source fiber via a standard RHP or SMA type coupling 236. Thus, as presently embodied, the hand-held piece 230 can be rotated about a longitudinal axis of the shaft portion. An angle A1 between the longitudinal axis of the shaft portion 236 and a line normal to the target surface is preferably set at one of 0, 15, 30, 45, 60, 75, and 90 degrees. In a modified embodiment, the hand-held piece 230 may be adjustable between some or all of these angles. The line normal to the target surface, in accordance with one preferred embodiment, is defined to be parallel to a longitudinal axis of one of the tissue contacting arms 240. In an embodiment wherein two tissue contacting arms 240 are used, the “line normal to the target surface” can be defined as a line parallel to a plane containing both of the tissue contacting arms. Another way of defining A1 is the angle, measured from the longitudinal axis of the shaft portion 236, to which the parabolic mirror or prism 232 bends the electromagnetic radiation. In an embodiment wherein the angle A1 is zero, the parabolic mirror or prism 232 may be omitted altogether. The rotatable shaft portion and angle A1 constructions may similarly be incorporated into the constructions of FIGS. 20-24.

The hand-held piece 230 preferably comprises an air line 242 and a water line 244 both of which feed into a mixing chamber 246 for mixing thereof, and for the subsequent emission of water particles from the moisture output 248, preferably into an interaction zone within the path of electromagnetic radiation from the lens 234. A vacuum source 250 is preferably disposed in at least one of the tissue contacting arms 240. The vacuum source 250 is preferably constructed, and disposed at a height, sufficient to remove excess water and not to interfere with the target surface. As with the embodiments of FIGS. 20-24, the tissue contacting arms may be part of and form an enclosure, such as a hemispherical enclosure, to enhance the efficacy of the vacuum source 250.

As an alternative to the mixing chambers 246, mist disks, such as illustrated in FIGS. 14-16, may be fitted between the tissue contacting arms 240 for providing, among other things, a spacing between the hand-held pieces and the target surface. As another alternative to the mixing chambers 246, one or more atomizers, mist generators, or moist air outputs (fluid outputs) may be disposed in, connected to or fitted between the tissue contacting arms 212. These mist disks may also provide the suction means, or the suction means may be provided above or below the mist disks or fluid outputs, such as at or near the ports 250 or 260. In one embodiment these spacing means can be about 3 millimeters in height or may be constructed to provide bounded layers of atomized fluid particles, for example, of about 3 millimeters in height. Other substantially different sizes for different heights may be used in other embodiments and in accordance with design parameters. When a substantially non-thermal cutting effect is desired in accordance with one aspect of the present invention, for example, the height of the spacing means can be varied so long as the resulting electromagnetically-induced disruptive forces are imparted onto the target surface, preferably without charring. The size and height of the spacing means can range, for example, in accordance with the target, laser, and type and distribution of air and/or fluid particles selected. A collimated beam, for example, may facilitate greater dimensions in the spacing means.

The mist disks for use with the hand-held piece 230 may comprise feet 262, as shown in FIG. 26. In FIG. 26 the tissue contacting arms 240 are modified, in accordance with one aspect of the present invention, to accommodate mist disks or mist apparatus 263 with feet 262. The mist apparatus 263 are preferably fed by air and/or water lines (not shown), which empty into mixing chambers 265 formed by the mist apparatus 263. The mixing chambers 265 form moisture outputs for outputting fluid particles into, for example, the path of the electromagnetic radiation.

As with the embodiments of FIGS. 20-25, the mixing chambers 265 and moisture outputs may comprise nozzles, which may be either permanently installed or interchangeable. Different nozzles may be configured to generate different angles of output and/or different fluid flow characteristics, such as different densities and distributions of atomized fluid particles. The above discussions of engineered combinations of atomized fluid particles is incorporated herein by reference. Light or heavy densities of atomized fluid particles, and particles of different sizes, may be engineered, for example. Wide angle insertable nozzles, for example, may generate relatively wide cone angles of atomized fluid particles (e.g., cones spanning plus or minus 45 degrees from a line parallel to the target surface), and narrow angle insertable nozzles may generate relatively narrow cone angles of atomized fluid particles (e.g., cones spanning plus or minus 15 degrees from a line spanning from the atomizer to the point of contact of the electromagnetic energy and the target surface).

The illustrated embodiment of FIG. 26 shows the modified tissue contacting arms 240 extending in a substantially parallel fashion for accommodating the removable mist apparatus 263. The mist apparatus 263, may be formed of stainless steel, for example, or of a disposable material, such as plastic, in accordance with one embodiment of the present invention. Part or all of the plastic may be transparent in accordance with another aspect of the present invention. The fluid particle generating apparatus 263 may comprise one post 264 for each modified tissue contacting arm 240. The posts may be connected or separate, or may comprise a cylinder or semi-cylinder. Moreover, each of the posts 264 of the fluid particle generating apparatus 263 may comprise one or more vacuum sources. The distal ends of the feet 262 are preferably rounded or smooth-surfaced to allow the feet 262 to glide over the target surface, such as a patient's skin. In modified embodiments, the feet 262 may comprise ball rollers. As with the embodiments of FIGS. 20-25, water from the moisture output can help to allow the tissue contacting arms to slide over the target surface. In one embodiment, soft water or another fluid, or an additive to water, having lubricating properties, may be emitted from the moisture output.

In other modified embodiments, single-nozzle moisture outputs oriented to output distributions of fluid particles preferably in directions substantially perpendicular to directions of incidence of the electromagnetic radiation, such as shown in FIG. 24, can be implemented. In addition, a piezoelectric atomizer for generating a fine spray may be used. Moreover, various configurations implementing fluid injectors, having structures similar to fuel injectors of internal combustion engines, for example, may be used to generate atomized distributions of fluid particles.

In other modified embodiments, only a single line, as distinguished from separate water and separate air lines, is used to deliver moist air. The moist air may comprise a colloidal suspension of water droplets, very humid air (about 100% humid), cool or cold steam as from a cold humidifier, or water vapor from dry ice. A pulsing valve may be incorporated to control the delivery of fluid. In another embodiment, a mono-water droplet dispersor may be used to supply single droplets, or droplets of relatively small numbers, to the interaction zone. Sprays can be used which are fed only by water without any assistance by an air line. A nebulizer, which uses air pressure and water to output atomized fluid particles through a small orifice, can be implemented. The nebulizer may comprise an ultrasonic or sonic device, and the atomized fluid particles may comprises water droplets having diameters ranging from about 5 to about 20 microns, or larger.

In accordance with the present invention, the fluid particles placed above the target surface may comprise materials other than, or in addition to, water. The fluid may comprise, for example, a medicated substance, a sterilized substance, or an anesthetic. U.S. Pat. No. 5,785,521 is expressly incorporated herein by reference to disclose, for example, various means and types of conditioned fluids which may be used in conjunction with a source of electromagnetic energy.

The present invention, which implements electromagnetically induced cutting to cut, remove, or otherwise impart disruptive forces onto relatively large surface areas of an epidermis, can be implemented on other target surfaces as well.

The present invention is not intended to be limited to operating on skin, or even tissue. One preferred application, however, involves removing tissue from relatively large surface areas of the epidermis for cosmetic purposes. For example, cosmetic surgery may be implemented using the present device on the face of a patient. Other conventional means for scanning a collimated or non-collimated beam, which are not disclosed above, may be implemented for achieving this purpose. The apparatus of the present invention, however, differs from the prior art in implementing the distributions of fluid particles or moist air between or within the impinging electromagnetic energy and the target surface. A particular laser source, as disclosed in U.S. application Ser. No. 08/903,187 is preferred, the contents of which are expressly incorporated herein by reference.

In a presently preferred embodiment of cosmetic surgery on the epidermis of a patient, the fluid particles or moist air may comprise at least one anesthesia and/or medication. Medications can include drugs for relieving pain (analgesics), such as Acetaminophen; drugs for causing a loss of general sensation (anesthetics) and vasal constrictors, such as lidocaine, epinephrine, or a combination of lidocaine and epinephrine; and substances able to kill or inhibit growth of certain microorganisms (antibiotics), such as penicillin or tetracycline. In the category of anesthetics, one composition would comprise lidocaine+diethyl-amimacet-2,6-xylidins. Epinephrine can be added to this composition, and the resulting product may provide an anesthetic affect for a period from about 45 minutes to 3 hours. Amino esters may also be used as anesthetics in other embodiments, wherein such amino esters may comprise, for example, procaine, 2-chloroprocaine and/or tetracine. In other embodiments, lidocaine can be combined with one or more of prilocaine, etidocaine, mepiracaine and bupivacaine. The medications can be emitted from a separate channel and/or orifice, or can be emitted from the moisture outputs.

In one embodiment of the present invention, botulinum toxin can be emitted from the moisture outputs, preferably on a final pass, for preventing wrinkling of the skin during healing. Botulinum toxin is a generic term embracing the family of toxins produced by the anaerobic bacterium Clostridium botulinum and, to date, seven immunologically distinct neurotoxins serotype have been identified. These have been given the designations A, B, C, D, E, F and G. For further information concerning the properties of the various botulinum toxins, reference is made to the article by Jankovic and Brin, The New England Journal of Medicine, Vol. 324, No. 17, 1990, pp. 1186-1194, and to the review by Charles L. Hatheway in Chapter 1 of the book entitled Botulinum Neurotoxin and Tetanus Toxin, L. L. Simpson, Ed., published by Academic Press Inc. of San Diego, Calif., 1989, the disclosures in which are incorporated herein by reference. Botulinum toxin is obtained commercially by establishing and growing cultures of C. botulinum in a fermenter and then harvesting and purifying the fermented mixture in accordance with known techniques. Botulinum toxin type A, the toxin type generally utilized in treating neuromuscular conditions, is currently available commercially from several sources; for example, from Porton Products Ltd. UK, under the trade name “DYSPORT,” and from Allergan, Inc., Irvine, Calif., under the trade name BOTOX.®. Botulinum Toxin Type A purified complex. In other embodiments, any of the serotypes B through G of Botulinum neurotoxin may be used, as well. The medications can be emitted from a separate channel and/or orifice, or can be emitted from the moisture outputs.

When multiple passes of the electromagnetically induced cutter are conducted over the surface being ablated, the medication and/or anesthesia within the atomized fluid particles is continuously delivered onto the tissue, to thereby hydrate, relax, medicate, and/or otherwise treat or medicate the tissue. In alternative embodiments, the mist is applied only on the second (e.g., immediately following) and subsequent (e.g., immediately following) passes over the surface. The mist may be applied at selected times during a single pass, and/or may be applied during selected passes (e.g., consecutive passes immediately following one another) of the laser over the surface. Similarly, the type of conditioning of the fluid may be selectively applied.

According to one aspect of the present invention, materials can be removed in one embodiment from a target surface by cutting forces different from conventional thermal cutting forces. In another embodiment, the apparatus of the present invention can be used to impart thermal energy onto the tissue subsequent to (e.g., immediately following) the substantially non-thermal cutting or ablating, for inducing deep cutting and coagulation, for example. For example, a first scan can induce non-thermal or reduced thermal cutting, and a subsequent (e.g., immediately following) scan can be used to apply thermal energy to the surface for inducing coagulation. In yet another embodiment, a reduced amount of atomized fluid particles (or moisture) may be used to simultaneously impart a combination of at least partially mechanical cutting (from expanding moisture) and thermal cutting (from the laser to impart coagulation, for example).

In one particular embodiment, a first pass over the surface of primarily non-thermal cutting is implemented with the fluid from the moisture output preferably comprising an anesthetic and a vasal constrictor (e.g., epinephrin). In this first pass, portions of the epidermis are preferably removed. A second pass is then (e.g., immediately following the first pass) performed, preferably with a lesser amount of fluid from the moisture output. The fluid is slightly or moderately reduced, or even eliminated, for greater cutting of the dermal layer of the skin and coagulation of vessels. For deeper wrinkles, additional passes (e.g., consecutive passes immediately following one another) similar to the second pass can be performed. Any of the above mentioned forms of Botulinum neurotoxin may be used an any point in time, such as, for example, as an after or in-between-laser treatment, to maintain skin smoothness. Prior art lasers typically do not apply any medication medium during the passing of laser over the skin, thereby causing the skin to become irritated and red. In contrast to prior art lasers which typically impart thermal cutting forces onto the skin, the electromagnetically induced cutter of the present invention, when operated in a non-thermal or reduced-thermal cutting mode in accordance with one aspect of the present invention, preferably does not deliver any substantial amount of heat to the tissue. As mentioned above, in this cutting mode the exploded atomized fluid particles are cooled by exothermic reactions before they contact the target surface. Thus, in accordance with one aspect of the present invention, atomized fluid particles of the present invention are heated, expanded, and cooled before contacting the target surface. Prior-art devices, which thermally operate on the skin, may have negative side effects associated therewith in connection with the medical procedure and the subsequent healing of the tissue. The present invention may, additionally, be able to ablate extremely thin layers of tissue, relative to existing laser skin surgery devices. Moreover, the non-thermal or reduced-thermal cutting mode, as a result of the mechanical cutting mechanism achieved from the expanding fluid particles, may be configured to cut at a particular depth of skin, so that only the crests of wrinkles are removed and part or all of the valleys are left in tact. The mechanical cutting nature of the non-thermal or reduced-thermal cutting mode may also be able to more evenly cut through hair and hair follicles, to thereby more evenly ablate the skin surface.

In accordance with one aspect of the present invention, substantially non-thermal cutting or reduced-thermal cutting alone, or in combination with the medicated atomized fluid particles, can serve to reduce erythema (skin redness) and reduce edema (swelling). Moreover, the present invention in accordance with one embodiment can serve to reduce unwanted thermal damage to adjacent tissue. For example, direct and/or adjacent melanocytes may not be substantially thermally affected with the present invention, thus attenuating hypo or hyper pigmentation effects, which can occur with prior-art chemical peel, derma-abrasion (use of wire brush), and thermal-cutting laser procedures. The present invention further can serve to reduce post and intra-operative pain and discomfort. For example, burning sensations and effects experienced by the patient can be attenuated.

Relatively small surface areas, or small thicknesses, of the skin may be treated in low wattage modes. Additionally, a relatively small amount of fluid may be used. Alternatively, the electromagnetic energy may be applied in a defocused mode, for a net decrease in energy density on the target surface.

The above-mentioned delivery of the atomized fluid particles, which may comprise medication and/or anesthesia, onto the skin during or close in time with the cutting or ablating operation serves to hydrate, relax, medicate, and/or otherwise treat or medicate the tissue. The atomized fluid particles may be delivered into the interaction zone contemporaneously with each pulse of electromagnetic radiation or, alternatively, may be continuously delivered into the interaction zone.

Although the hydration of the soft tissue is a benefit in accordance with one aspect of the present invention, too much water can interfere with the optimal execution of the medical procedure. A percentage of the atomized fluid particles not within the path of the electromagnetic radiation will accumulate on the surface of the target surface. Suction from the vacuum sources can be used to remove excess or unwanted liquid from the target surface or adjacent areas. Cut tissue can be carried by the excess water and removed by the suction. In one embodiment, the target surface can be oriented so that gravity will drain off unwanted liquid. The suction is preferably additionally, or alternatively, used to remove airborne atomized fluid particles that are not in the interaction zone. One or more suction channels may be placed in a mist disk, as mentioned above, for removing unwanted, airborne atomized fluid particles not within the path of the electromagnetic energy. The suction channels may be placed between moisture output channels at the same height, or at different heights in which case the suction channels may also be placed directly above or below the moisture outputs channels. Utilization of the above-mentioned moist air, alone or in combination with atomized fluid particles, may help to attenuate an amount of excess fluid accumulating on the target surface.

Although an exemplary embodiment of the invention has been shown and described, many other changes, modifications and substitutions, in addition to those set forth in the above paragraphs, may be made by one having ordinary skill in the art without necessarily departing from the spirit and scope of this invention.

1. A flashlamp current generating circuit, comprising:
a solid core inductor having an inductance of about 50 microhenries;
a capacitor coupled to the inductor, the capacitor having a capacitance of 50 microfarads; and
a flashlamp coupled to the solid core inductor.

2. A pulse for driving a flashlamp that is used as a stimulation source for a laser rod, comprising:
a leading edge having a slope which is greater than or equal to about 5, the slope being defined on a plot of the pulse as y over x (y/x) where y is current in amps and x is time in microseconds; and
a full-width half-max value in a range from 0.025 to 250 microseconds.

3. The pulse for driving a flashlamp as recited in claim 2, wherein the full-width half-max value is in a range from 10 to 150 microseconds.

4. The pulse for driving a flashlamp as recited in claim 3, wherein the full-width half-max value is about 70 microseconds.

5. The pulse for driving a flashlamp as recited in claim 2, wherein the slope is greater than or equal to about 10.

6. The pulse for driving a flashlamp as recited in claim 2, wherein the slope is greater than or equal to about 100.

7. The pulse for driving a flashlamp as recited in claim 6, wherein the slope is about 240.

8. A method, comprising:
directing energy and first amounts of moisture into an interaction zone above a target whereby the energy is moved over substantially an entire treatment area of the target and is highly absorbed by the moisture; and
immediately repeating the directing with second amounts of moisture that are less than the first amounts of moisture.

9. The method as recited in claim 8, wherein the moisture comprises an anesthetic and a vassal constrictor.

10. The method as recited in claim 8, wherein the energy is generated using the flashlamp current generating circuit of claim 1.

11. The method as recited in claim 8, wherein the energy is generated using the pulse of claim 2.

12. A flashlamp current generating circuit, comprising:
an inductor having an inductance less than about 16 microhenries;
a capacitor coupled to the inductor, the capacitor having a capacitance of 50 microfarads; and
a flashlamp coupled to the inductor.

13. The flashlamp current generating circuit as recited in claim 12, wherein the inductor comprises an inductance within a range of about 10 to 15 microhenries.

14. The flashlamp current generating circuit as recited in claim 12, wherein the inductor comprises a solid core inductor.

15. The flashlamp current generating circuit as recited in claim 14, wherein the a solid core inductor has a rated inductance of about 50 microhenries
